(19) United States
(12) Patent Application Publication
(10) Pub. No.: US 2025/0048223 A1
(43) Pub. Date: Feb. 6, 2025

(54) HANDOVER CONTROL CONSIDERING LOWER LAYER MOBILITY

(71) Applicant: Nokia Technologies Oy, Espoo (FI)

(72) Inventors: Subramanya CHANDRASHEKAR, Bangalore (IN); Srinivasan SELVAGANAPATHY, Bangalore (IN); Tero HENTTONEN, Espoo (FI)

(21) Appl. No.: 18/719,607

(22) PCT Filed: Dec. 6, 2022
(86) PCT No.: PCT/EP2022/084614

§ 371 Date: Jun. 13, 2024

(30) Foreign Application Priority Data
Dec. 13, 2021 (IN) 202141057924

(51) Int. Cl. H04W 36/36; H04W 36/08

(52) U.S. Cl. CPC H04W 36/362; H04W 36/087

(57) ABSTRACT

An apparatus for use by a communication network control element or communication network control function configured to control a communication of at least one communication element or function in a communication network, the apparatus comprising at least one processing circuitry, and at least one memory for storing instructions to be executed by the processing circuitry, wherein the at least one memory and the instructions are configured to, with the at least one processing circuitry, cause the apparatus at least: to determine a reference configuration to be used for preparing a first type of mobility procedure for a communication element or communication function which is configured to conduct a second type of mobility procedure being different to the first type of mobility procedure, to cause transmission, to a target communication network control element or communication network control function to which the communication of the communication element or communication function is to be changed, of a request for preparing a target cell configuration for execution of the first type of mobility procedure, wherein the request includes information indicating the reference configuration, to receive, from the target communication network control element or communication network control function, a response to the request for preparing the target cell configuration for execution of the first type of mobility procedure, the response including an indication of the reference configuration and configuration information of a target cell for the first type of mobility procedure for the communication element or communication function, and to cause transmission, to the communication element or communication function, of a command for executing the first type of mobility procedure, the command including the indication of the reference configuration and the configuration information of the target cell for the first type of mobility procedure.

### BACKGROUND

### Field

Examples of embodiments relate to apparatuses, methods, systems, computer programs, computer program products and (non-transitory) computer-readable media usable for controlling a handover procedure wherein lower layer mobility is considered. Specifically, examples of embodiments relate to apparatuses, methods, systems, computer programs, computer program products and (non-transitory) computer-readable media usable for enabling to execute a handover procedure in a higher layer, such as an L3 handover procedure for changing an access node, such as gNBs, when lower layer mobility, such a L1/L2 centric inter cell mobility, is configured, without conflict.

### Background Art

The following description of background art may include insights, discoveries, understandings or disclosures, or associations, together with disclosures not known to the relevant prior art, to at least some examples of embodiments of the present disclosure but provided by the disclosure. Some of such contributions of the disclosure may be specifically pointed out below, whereas other of such contributions of the disclosure will be apparent from the related context.

The following meanings for the abbreviations used in this specification apply:
3GPP 3^{rd} Generation Partnership Project
4G fourth generation
5G fifth generation
5GS 5G system
ACK acknowledgement
AF application function
AP application protocol
CE control element
CP control plane
CPU central processing unit
CU centralized unit
DU distributed unit
eNB E-UTRAN Node B
gNB next generation node B
HO handover
ICBM inter-cell beam management
ID identification
IP Internet protocol
LTE Long Term Evolution
LTE-A LTE Advanced
MAC medium access control
MIMO multiple input multiple output
MP measurement report
NR new radio
NW network, network side
PCI physical cell identity
PDCP packet data convergence protocol
RACH random access channel
RLF radio link failure
RRC radio resource control
RSRP reference signal received power
RSRQ reference signal received quality
SDAP service data adaptation protocol
TCI transmission control information
TRP transmit receive point
UE user equipment
UP user plane

### SUMMARY

According to an example of an embodiment, there is provided, for example, an apparatus for use by a communication network control element or communication network control function configured to control a communication of at least one communication element or function in a communication network, the apparatus comprising at least one processing circuitry, and at least one memory for storing instructions to be executed by the processing circuitry, wherein the at least one memory and the instructions are configured to, with the at least one processing circuitry, cause the apparatus at least: to determine a reference configuration to be used for preparing a first type of mobility procedure for a communication element or communication function which is configured to conduct a second type of mobility procedure being different to the first type of mobility procedure, to cause transmission, to a target communication network control element or communication network control function to which the communication of the communication element or communication function is to be changed, of a request for preparing a target cell configuration for execution of the first type of mobility procedure, wherein the request includes information indicating the reference configuration, to receive, from the target communication network control element or communication network control function, a response to the request for preparing the target cell configuration for execution of the first type of mobility procedure, the response including an indication of the reference configuration and configuration information of a target cell for the first type of mobility procedure for the communication element or communication function, and to cause transmission, to the communication element or communication function, of a command for executing the first type of mobility procedure, the command including the indication of the reference configuration and the configuration information of the target cell for the first type of mobility procedure.

Furthermore, according to an example of an embodiment, there is provided, for example, a method for use in communication network control element or communication network control function configured to control a communication of at least one communication element or function in a communication network, the method comprising determining a reference configuration to be used for preparing a first type of mobility procedure for a communication element or communication function which is configured to conduct a second type of mobility procedure being different to the first type of mobility procedure, causing transmission, to a target communication network control element or communication network control function to which the communication of the communication element or communication function is to be changed, of a request for preparing a target cell configuration for execution of the first type of mobility procedure, wherein the request includes information indicating the reference configuration, receiving, from the target communication network control element or communication network control function, a response to the request for preparing the target cell configuration for execution of the first type of mobility procedure, the response including an indication of the reference configuration and configuration information of a target cell for the first type of mobility procedure for the communication element or communication function, and causing transmission, to the communication element or communication function, of a command for executing the first type of mobility procedure, the command including the indication of the reference configuration and the configuration information of the target cell for the first type of mobility procedure.

According to further refinements, these examples may include one or more of the following features:
the reference configuration may be a resource configuration setting used by the communication element or communication function in one of a primary cell associated with the second type of mobility procedure, designated in the part of the communication network controlled by the communication network control element or communication network control function, a current serving cell of the part of the communication network controlled by the communication network control element or communication network control function, and a previously used serving cell of the part of the communication network controlled by the communication network control element or communication network control function, wherein the previously used serving cell was used under a specified condition and it is known that the resource configuration setting used in the previously used serving cell is available for the communication element or communication function;
the information indicating the reference configuration and included in the request for preparing the target cell configuration for execution of the first type of mobility procedure may include an identification of a cell for which the reference configuration is set, and an indication informing the target communication network control element or communication network control function to use the reference configuration for preparing the target cell configuration for execution of the first type of mobility procedure and to include, in the target cell configuration, sent in response to the request, the identification of the cell for which the reference configuration is set;
the communication network control element or communication network control function may function as a centralized unit, the first type of the mobility procedure for the communication element or communication function may comprise a layer 3 related handover procedure of the communication from the communication network control element or function to the target communication network control element or target communication network control function, and the second type of the mobility procedure for the communication element or communication function may comprise a layer 1/layer 2 related handover procedure of the communication from one cell of the communication network part controlled by the communication network control element or communication network control function to another cell of the communication network part controlled by the communication network control element or communication network control function;
the response to the request for preparing the target cell configuration for execution of the first type of mobility procedure may include, as the indication of the reference configuration, an identification of the cell for which the reference configuration is set, wherein the configuration information of the target cell for the first type of mobility procedure for the communication element or communication function defines a delta configuration information considering differences between a resource configuration setting defined by the reference configuration and a resource configuration setting for the target cell of the first type of mobility procedure.

According to an example of an embodiment, there is provided, for example, an apparatus for use by a communication network control element or communication network control function configured to conduct a mobility procedure to change control of a communication of at least one communication element or function in a communication network, the apparatus comprising at least one processing circuitry, and at least one memory for storing instructions to be executed by the processing circuitry, wherein the at least one memory and the instructions are configured to, with the at least one processing circuitry, cause the apparatus at least: to receive, from a source communication network control element or communication network control function from which the communication of the communication element or communication function is to be changed, a request for preparing a target cell configuration for execution of a first type of mobility procedure, wherein the request includes information indicating a reference configuration to be used for preparing the target cell configuration for the first type of mobility procedure, to conduct a process for preparing the target cell configuration for execution of the first type of mobility procedure, wherein the process comprises a determination of configuration information for a target cell for the first type of mobility procedure for the communication element or communication function considering the reference configuration, and to cause transmission, to the source communication network control element or communication network control function, a response to the request for preparing the target cell configuration for execution of the first type of mobility procedure, the response including an indication of the reference configuration as a part of the configuration information of the target cell for the first type of mobility procedure for the communication element or communication function.

Furthermore, according to an example of an embodiment, there is provided, for example, a method for use in a communication network control element or communication network control function configured to conduct a mobility procedure to change control of a communication of at least one communication element or function in a communication network, the method comprising receiving, from a source communication network control element or communication network control function from which the communication of the communication element or communication function is to be changed, a request for preparing a target cell configuration for execution of a first type of mobility procedure, wherein the request includes information indicating a reference configuration to be used for preparing the first type of mobility procedure, conducting a process for preparing the target cell configuration for execution of the first type of mobility procedure, wherein the process comprises a determination of configuration information for a target cell for the first type of mobility procedure for the communication element or communication function considering the reference configuration, and causing transmission, to the source communication network control element or communication network control function, a response to the request for preparing the target cell configuration for execution of the first type of mobility procedure, the response including an indication of the reference configuration as a part of the configuration information of the target cell for the first type of mobility procedure for the communication element or communication function.

According to further refinements, these examples may include one or more of the following features:
the information indicating the reference configuration and included in the request for preparing the target cell configuration for execution of the first type of mobility procedure may include an identification of a cell for which the reference configuration is set, and an indication informing the communication network control element or communication network control function to use the reference configuration for preparing the target cell configuration for execution of the first type of mobility procedure and to include, in the target cell configuration, which is sent in response to the request, the identification of the cell for which the reference configuration is set;
the communication network control element or communication network control function may function as a centralized unit, the first type of the mobility procedure for the communication element or communication function may comprise a layer 3 related handover procedure of the communication from the source communication network control element or function to the communication network control element or communication network control function.
the response to the request for preparing the target cell configuration for execution of the first type of mobility procedure may include, as the indication of the reference configuration, an identification of the cell for which the reference configuration is set, wherein the configuration information of the target cell for the first type of mobility procedure for the communication element or communication function defines a delta configuration information considering differences between a resource configuration setting defined by the reference configuration and a resource configuration setting for the target cell of the first type of mobility procedure.

According to an example of an embodiment, there is provided, for example, an apparatus for use by a communication element or communication function configured to conduct a communication in a communication network, the apparatus comprising at least one processing circuitry, and at least one memory for storing instructions to be executed by the processing circuitry, wherein the at least one memory and the instructions are configured to, with the at least one processing circuitry, cause the apparatus at least: to receive, from a source communication network control element or communication network control function, a command for executing a first type of mobility procedure, the command including an indication of a reference configuration and configuration information of a target cell for the first type of mobility procedure, to process the command for executing the first type of mobility procedure, wherein the processing includes to compare the indication of the reference configuration with information specifying at least one of a currently used configuration and a stored configuration for the communication, in case that the comparison results in that the currently used or stored configuration does not match with the reference configuration, to obtain configuration information corresponding to the reference configuration, and to determine a target cell configuration for the first type of mobility procedure, and to conduct the first type of mobility procedure for changing the communication to a target communication network control element or target communication network control function on the basis of the determined target cell configuration.

Furthermore, according to an example of an embodiment, there is provided, for example, a method for use in a communication element or communication function configured to conduct a communication in a communication network, the method comprising receiving, from a source communication network control element or communication network control function, a command for executing a first type of mobility procedure, the command including an indication of a reference configuration and configuration information of a target cell for the first type of mobility procedure, processing the command for executing the first type of mobility procedure, wherein the processing includes to compare the indication of the reference configuration with information specifying at least one of a currently used configuration and a stored configuration for the communication, in case that the comparison results in that the currently used or stored configuration does not match with the reference configuration, obtaining configuration information corresponding to the reference configuration, and determining a target cell configuration for the first type of mobility procedure, and conducting the first type of mobility procedure for changing the communication to a target communication network control element or target communication network control function on the basis of the determined target cell configuration.

According to further refinements, these examples may include one or more of the following features:
the communication element or communication function may be further configured to conduct a second type of mobility procedure being different to the first type of mobility procedure;
the reference configuration may be a resource configuration setting used by the communication element or communication function in one of a primary cell associated with the second type of mobility procedure, designated in the part of the communication network controlled by the source communication network control element or communication network control function, and a currently or previously used serving cell of the part of the communication network controlled by the source communication network control element or communication network control function, wherein the resource configuration setting used in the previously used serving cell is available;
the indication of the reference configuration included in the command for executing the first type of mobility procedure may include an identification of a cell for which the reference configuration is set;
the source communication network control element or source communication network control function may function as a centralized unit, the first type of the mobility procedure for the communication element or communication function may comprise a layer 3 related handover procedure of the communication from the source communication network control element or source communication network control function to the target communication network control element or target communication network control function, and a second type of mobility procedure for which the communication element or communication function is configured may comprise a layer 1/layer 2 related handover procedure of the communication from one cell of the communication network part controlled by the source communication network control element or source communication network control function to another cell of the communication network part controlled by the source communication network control element or source communication network control function;
the indication of the reference configuration may include an identification of a cell for which the reference configuration is set, wherein the configuration information of the target for the first type of mobility procedure for the communication element or communication function defines a delta configuration information considering differences between a resource configuration setting defined by the reference configuration and a resource configuration setting for the target cell of the first type of mobility procedure.

In addition, according to embodiments, there is provided, for example, a computer program product for a computer, including software code portions for performing the steps of the above defined methods, when said product is run on the computer. The computer program product may include a computer-readable medium on which said software code portions are stored. Furthermore, the computer program product may be directly loadable into the internal memory of the computer and/or transmittable via a network by means of at least one of upload, download and push procedures.

### BRIEF DESCRIPTION OF THE DRAWINGS

Some embodiments of the present disclosure are described below, by way of example only, with reference to the accompanying drawings, in which:

FIG. 1 shows a diagram illustrating an example of a network architecture in which examples of embodiments are implementable;

FIG. 2 shows a diagram illustrating an example of a mobility scenario;

FIG. 3 shows a signaling diagram illustrating an example of a mobility scenario;

FIG. 4 shows a signaling diagram illustrating an example of a mobility scenario according to examples of embodiments;

FIG. 5 shows a flow chart of a processing conducted in a communication network control element or communication network control function being a source node in a mobility scenario according to some examples of embodiments;

FIG. 6 shows a flow chart of a processing conducted in a communication network control element or communication network control function being a target node in a mobility scenario according to some examples of embodiments;

FIG. 7 shows a flow chart of a processing conducted in a communication element or communication function in a mobility scenario according to some examples of embodiments;

FIG. 8 shows a diagram of a communication network control element being a source node in a mobility scenario according to some examples of embodiments;

FIG. 9 shows a diagram of a communication network control element being a target node in a mobility scenario according to some examples of embodiments; and

FIG. 10 shows a diagram of a communication element in a mobility scenario according to some examples of embodiments.

### DESCRIPTION OF EMBODIMENTS

In the last years, an increasing extension of communication networks, e.g. of wire based communication networks, such as the Integrated Services Digital Network (ISDN), Digital Subscriber Line (DSL), or wireless communication networks, such as the cdma2000 (code division multiple access) system, cellular 3^{rd} generation (3G) like the Universal Mobile Telecommunications System (UMTS), fourth generation (4G) communication networks or enhanced communication networks based e.g. on Long Term Evolution (LTE) or Long Term Evolution-Advanced (LTE-A), fifth generation (5G) communication networks, cellular 2^{nd} generation (2G) communication networks like the Global System for Mobile communications (GSM), the General Packet Radio System (GPRS), the Enhanced Data Rates for Global Evolution (EDGE), or other wireless communication system, such as the Wireless Local Area Network (WLAN), Bluetooth or Worldwide Interoperability for Microwave Access (WiMAX), took place all over the world. Various organizations, such as the European Telecommunications Standards Institute (ETSI), the 3^{rd} Generation Partnership Project (3GPP), Telecoms & Internet converged Services & Protocols for Advanced Networks (TISPAN), the International Telecommunication Union (ITU), 3^{rd} Generation Partnership Project 2 (3GPP2), Internet Engineering Task Force (IETF), the IEEE (Institute of Electrical and Electronics Engineers), the WiMAX Forum and the like are working on standards or specifications for telecommunication network and access environments.

In the following, different exemplifying embodiments will be described for illustrating a processing for executing a mobility procedure, such as a handover procedure, for a communication element, such as a UE, when different types of mobility are configured for this UE. For this, as an example of a communication network to which examples of embodiments may be applied, a communication network architecture based on 3GPP standards for a communication network, such as 5G/NR, is used, without restricting the embodiments to such an architecture, however. It is obvious for a person skilled in the art that the embodiments may also be applied to other kinds of communication networks, e.g. Wi-Fi, worldwide interoperability for microwave access (WiMAX), Bluetooth®, personal communications services (PCS), ZigBee®, wideband code division multiple access (WCDMA), systems using ultra-wideband (UWB) technology, mobile ad-hoc networks (MANETs), wired access, etc., Furthermore, without loss of generality, the description of some examples of embodiments is related to a mobile communication network, but principles of the disclosure can be extended and applied to any other type of communication network, such as a wired communication networks as well.

The following examples and embodiments are to be understood only as illustrative examples. Although the specification may refer to “an”, “one”, or “some” example(s) or embodiment(s) in several locations, this does not necessarily mean that each such reference is related to the same example(s) or embodiment(s), or that the feature only applies to a single example or embodiment. Single features of different embodiments may also be combined to provide other embodiments. Furthermore, terms like “comprising” and “including” should be understood as not limiting the described embodiments to consist of only those features that have been mentioned; such examples and embodiments may also contain features, structures, units, modules etc. that have not been specifically mentioned.

A basic system architecture of a (tele) communication network including a mobile communication system where some examples of embodiments are applicable may include an architecture of one or more communication networks including wireless access network subsystem(s) and core network(s). Such an architecture may include one or more communication network control elements or functions, access network elements, radio access network elements, access service network gateways or base transceiver stations, such as a base station (BS), an access point (AP), a NodeB (NB), an eNB or a gNB, a distributed or a centralized unit, which controls a respective coverage area or cell(s) and with which one or more communication stations such as communication elements, user devices or terminal devices, like a UE, or another device having a similar function, such as a modem chipset, a chip, a module etc., which can also be part of a station, an element, a function or an application capable of conducting a communication, such as a UE, an element or function usable in a machine-to-machine communication architecture, or attached as a separate element to such an element, function or application capable of conducting a communication, or the like, are capable to communicate via one or more channels via one or more communication beams for transmitting several types of data in a plurality of access domains. Furthermore, core network elements or network functions, such as gateway network elements/functions, mobility management entities, a mobile switching center, servers, databases and the like may be included.

The general functions and interconnections of the described elements and functions, which also depend on the actual network type, are known to those skilled in the art and described in corresponding specifications, so that a detailed description thereof is omitted herein. However, it is to be noted that several additional network elements and signaling links may be employed for a communication to or from an element, function or application, like a communication endpoint, a communication network control element, such as a server, a gateway, a radio network controller, and other elements of the same or other communication networks besides those described in detail herein below.

A communication network architecture as being considered in examples of embodiments may also be able to communicate with other networks, such as a public switched telephone network or the Internet, as well as with individual devices or groups of devices being not considered as a part of a network, such as monitoring devices like cameras, sensors, arrays of sensors, and the like. The communication network may also be able to support the usage of cloud services for virtual network elements or functions thereof, wherein it is to be noted that the virtual network part of the telecommunication network can also be provided by non-cloud resources, e.g. an internal network or the like. It should be appreciated that network elements of an access system, of a core network etc., and/or respective functionalities may be implemented by using any node, host, server, access node or entity etc. being suitable for such a usage. Generally, a network function can be implemented either as a network element on a dedicated hardware, as a software instance running on a dedicated hardware, or as a virtualized function instantiated on an appropriate platform, e.g., a cloud infrastructure.

Furthermore, a network element or network functions, such as an access node like a gNB, or a communication element such as a UE, or other network elements or network functions, as described herein, and any other elements, functions or applications may be implemented by software, e.g. by a computer program product for a computer, and/or by hardware. For executing their respective processing, correspondingly used devices, nodes, functions or network elements may include several means, modules, units, components, etc. (not shown) which are required for control, processing and/or communication/signaling functionality. Such means, modules, units and components may include, for example, one or more processors or processor units including one or more processing portions for executing instructions and/or programs and/or for processing data, storage or memory units or means for storing instructions, programs and/or data, for serving as a work area of the processor or processing portion and the like (e.g. ROM, RAM, EEPROM, and the like), input or interface means for inputting data and instructions by software (e.g. floppy disc, CD-ROM, EEPROM, and the like), a user interface for providing monitor and manipulation possibilities to a user (e.g. a screen, a keyboard and the like), other interface or means for establishing links and/or connections under the control of the processor unit or portion (e.g. wired and wireless interface means, radio interface means including e.g. an antenna unit or the like, means for forming a radio communication part etc.) and the like, wherein respective means forming an interface, such as a radio communication part, can be also located on a remote site (e.g. a radio head or a radio station etc.). It is to be noted that in the present specification processing portions should not be only considered to represent physical portions of one or more processors, but may also be considered as a logical division of the referred processing tasks performed by one or more processors.

It should be appreciated that according to some examples, a so-called “liquid” or flexible network concept may be employed where the operations and functionalities of a network element, a network function, or of another entity of the network, may be performed in different entities or functions, such as in a node, host or server, in a flexible manner. In other words, a “division of labor” between involved network elements, functions or entities may vary case by case.

An important element of (mobile) telecommunication systems is mobility, which is also called handover (HO) allowing to change the communication connection from one network node (access node) to another. The basic handover procedure is usually based on measurement reports from the communication element or function, i.e. a UE or the like, regarding neighbor cell PCI and signal strength to a source node or cell. The source node makes a decision to start a handover procedure to a suitable target node or cell, and the handover is completed with that target cell.

Current systems use different types of mobility (i.e. HO procedures), like intra system handover, inter frequency, intra frequency and inter sector handovers.

In addition to the above indicated handover approached, the so-called disaggregated gNB-DU and gNB-CU architecture allows to consider further handover types.

In the disaggregated configuration, an access node, i.e. a gNB of a 5G communication system, is divided into two entities named centralized unit (CU) and distributed unit (DU).

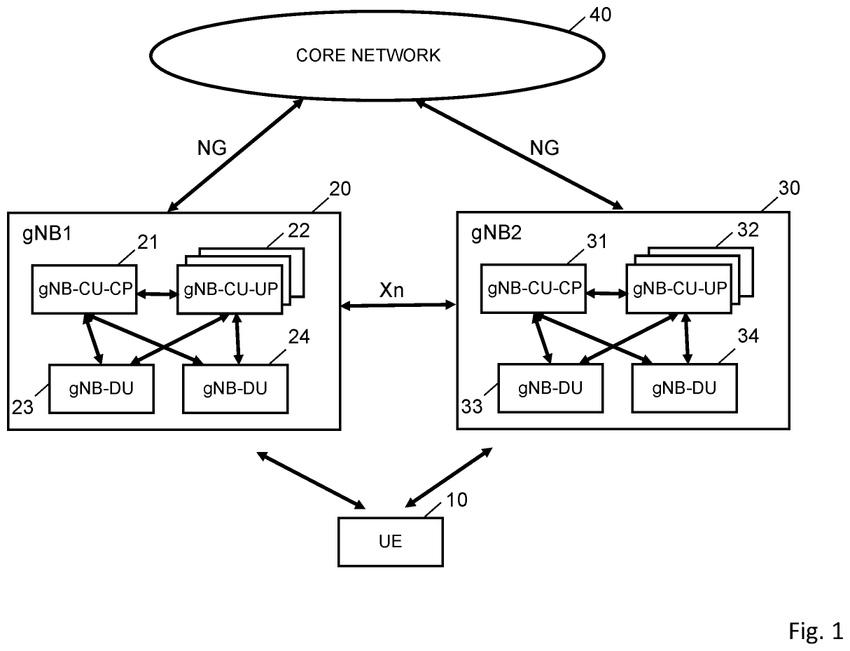

FIG. 1 shows an example of a network architecture representing a disaggregated configuration, in which also examples of embodiments are implementable. Specifically, FIG. 1 shows a diagram illustrating an example of a system architecture of a communication network based on 3GPP. It is to be noted that the illustration in FIG. 1 mainly shows those parts of a complete network architecture which are useful for understanding principles of embodiments of the disclosure, while other elements and interfaces are omitted in the illustration.

Reference number 10 denotes a communication element or communication function, i.e. a UE, which is able to communicate in the communication network and for which different types of mobility procedures can be realized.

Reference numbers 20 and 30 denote a respective communication network control element or communication network control function which is able to provide, to the UE 10, access to the communication network. In the illustrated example, the communication network control elements or communication network control functions 20, 30 are a gNB representing a base station of the 5G network which is able to communicate with the UE 10 via a corresponding air interface. As indicated in FIG. 1, an interface between the gNBs is provided, which is referred to as Xn.

It is to be noted that while FIG. 1 shows two gNBs, there may be more gNBs in the network structure. Furthermore, gNB 20 is also referred to as gNB1 or source gNB (source node) for mobility considerations, while gNB 30 is also referred to as gNB2 or target gNB (target node) for mobility considerations

Reference sign 40 denotes a core network structure of the communication network which is connected to each gNB 20, 30 via an interface NG. Elements and functionality of the core network 40 is known to a person skilled in the art so that a complete description thereof is omitted here.

In the following, the configuration of the gNBs 20, 30 is further described. As indicated above, the gNBs 20, 30 are assumed to have a disaggregated configuration.

In the gNBs 20, 30, respectively, a gNB-CU is provided, wherein a further division into control plane (CP) and user place (UP) relation is made. That is, gNB 20 comprises a gNB-CU-CP 21 and one or more gNB-CU-UP 22, while gNB 30 comprises a gNB-CU-CP 31 and one or more gNB-CU-UP 32.

Moreover, in the gNBs 20, 30, respectively, one or more gNB-DUs are provided. That is, gNB 20 comprises a gNB-DU 23 and a gNB-DU 24, while gNB 30 comprises a gNB-DU 33 and a gNB-DU 34.

Regarding the functionality of the elements in the disaggregated configuration, the gNB-CU provides support for higher layers of the protocol stack such as SDAP, PDCP and RRC while the gNB-DU provides support for lower layers of the protocol stack such as RLC, MAC and Physical layer. Scheduling operations take place at the gNB-DU.

In general, there is provided a single gNB-CU for each gNB. One gNB-CU may control one or more gNB-DUs (for example 100 gNB-DUs or more can be connected to one gNB-CU). Each gNB-DU is able to host one or more cells (for example, 512 according to specifications), so that one (combined) gNB is able to control hundreds of cells (unlike in former network systems such as 4G based).

The interface between the gNB-CU and gNB-DU(s) is referred to as F1 (F1-C, F1-U, depending on control plane or user plane relation), while the interface between the gNB-CU-CP and the gNB-CU-UP is referred to as E1.

Regarding the HO approaches based on the disaggregated configuration illustrated in FIG. 1, as mentioned above, the gNB-DU and gNB-CU implementation allows for the following types of handovers:
intra gNB-DU HO (between cells controlled by the same gNB-DU)
inter gNB-DU HO and intra gNB-CU HO (source and target gNB-DU are connected to a common gNB-CU, i.e. are part of the same gNB), and
inter gNB-CU HO (i.e. HO between gNB1 and gNB2, for example).

In the above indicated scenarios, in case of intra gNB-DU HO and inter gNB-DU HO, the signaling in the handover procedure involve messaging over F1 interface using F1AP protocols and over E1 interface using E1AP protocols. That is, lower level signaling (e.g. L1/L2 signaling) can be used to execute a handover, while any signaling exchange towards core network is not required, which would involve higher level signaling (e.g. L3 signaling).

In order to support transmission and reception of multiple beams from different cells, inter-cell multiTRP (mTRP) operation is implemented. One approach in this concept is that in addition to a support of intra-DU mTRP operation also a broader concept is considered to as to extend the support also for change of serving-cell via L1/L2 based mechanisms in both intra-DU and inter-DU scenarios.

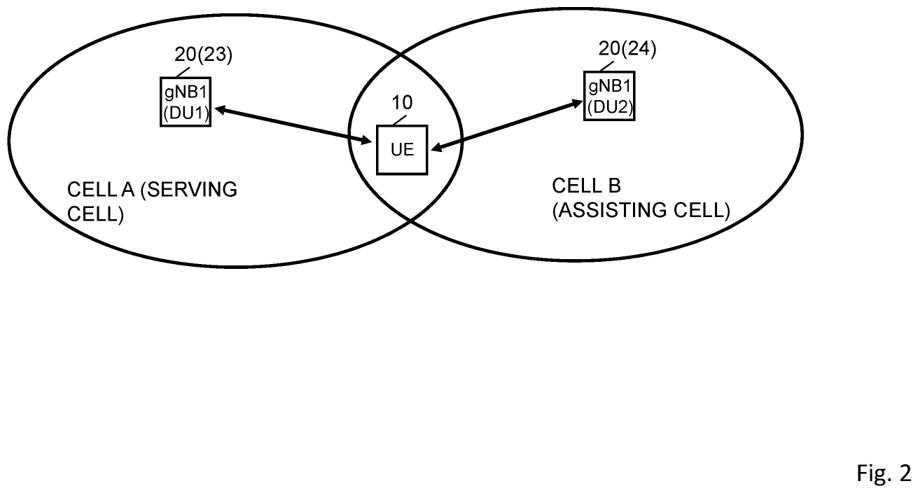

FIG. 2 illustrates an example of a mobility scenario in which an inter-DU HO is assumed. Specifically, it is assumed that the UE 10 is located in a cell A (serving cell) controlled by gNB1 20, that is by gNB-DU 23, for example. Due to mobility of UE 10, for example, a HO to another cell is considered, i.e. to cell B (referred to as assisting cell or non-serving cell) which is controlled by gNB1 20, that is by gNB-DU 24.

In order to support an L1/L2 centric inter-cell change (i.e. change of serving cell) in the disaggregated gNB architecture, it is necessary that the UE configuration can be delivered using RRC protocol by gNB-CU-CP, but executed autonomously by the gNB-DU without further interaction with the upper layers.

However, since L1 measurements, which are required for L1 centric HO, for example, are unfiltered, it is likely that so-called ping-pong effects in a handover between cells considered for L1 mobility can happen. Such a ping-pong effect may cause a quick change of serving cells in a DU (based on L1 mobility commands). For different reasons (e.g. paging or inter-gNB HO preparation etc.), the DU may be assumed to notify the CU-CP whenever an L1 based serving cell change is executed successfully. This ensures that the CU-CP is aware of the UE's current serving cell and hence takes appropriate actions based on it.

However, it is found out that there may be a race condition which possibly disturbs the mobility procedure. This is explained in the following.

Basically, there can be different reasons why the gNB (i.e. the gNB-CU-CP) triggers a HO to another gNB (e.g. from gNB1 to gNB2), i.e. an inter-gNB L3 mobility procedure. Such reasons are, for example, radio conditions based on L3 measurements, a load based intra or inter frequency HO, an inter-frequency HO, a service based HO (for example addition of voice data radio bearers or another service), or a slice re-mapping based HO.

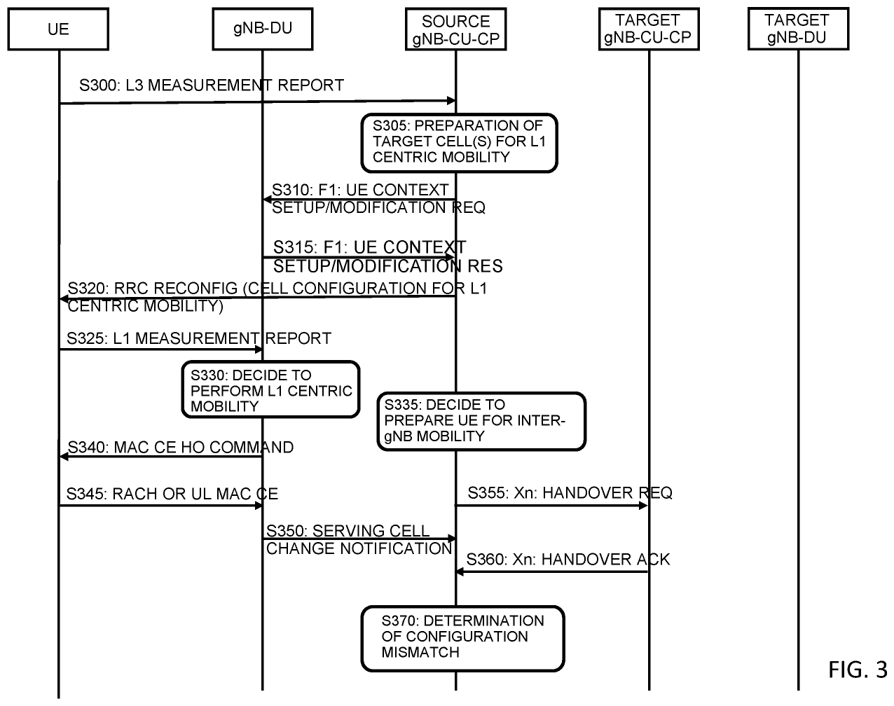

FIG. 3 shows a signaling diagram illustrating an example of a mobility scenario in which a L1/L2 centric inter-cell mobility and a L3 inter-gNB mobility procedure is possible.

According to the example presented in FIG. 3, it is assumed that the gNB-CU-CP of the source node (i.e. the currently serving cell) configures one or more intra or inter DU cells for L1/L2 centric inter-cell mobility. This is done by using a RRC configuration. The corresponding cell information and its configuration can be decided by the DU and then conveyed to the CU. Alternatively, the CU may also ask the DU for the configuration pertaining to some cells (e.g. based on the L3 measurements). Then, corresponding configuration information is provided by the CU to the UE.

It is to be noted that the gNB-CU-CP also configures the UE for both L1 RSRP and L3 measurements, while providing the RRC configurations for the cells prepared for L1 centric mobility.

That is, in the signaling diagram in FIG. 3, in S300, the source gNB-CU-CP receives L3 measurement results (e.g. by using a measurement report information) from the UE. The L3 measurements are sent over RRC protocol to the gNB-CU-CP. As indicated above, L3 measurements are used, for example, in the inter-gNB mobility procedure and are normally transparent to the DU and hence considered not accessible.

In S305, the gNB-CU-CP conducts the preparation of one or more target cells for L1 centric inter-cell mobility.

In S310, the gNB-CU-CP sends a UE context setup or modification request to the gNB-DU by using the F1 interface. By means of this, a UE context is created and bearers are setup, for example.

In S315, the gNB-DU responds to the UE context setup or modification request with a corresponding response message via F1 interface with identity and bearer information.

In S320, the gNB-CU-CP sends to the UE a RRC reconfiguration request which includes the cell configuration information for the cells selected for L1 centric mobility.

In S325, the UE sends L1 RSRP measurements over L1/MAC protocol to the gNB-DU. This measurement is used for an intra-DU or inter-DU L1 based mobility. According to example, the CU is not aware of the L1 measurements as the beam management is only done at DU level.

In S330, the gNB-DU evaluates the L1 measurement results (e.g. L1-RSRP, L1-RSRQ, indication from UE that event is triggered without any L1 measurement results) decides to command the UE to execute an intra-DU L1 centric serving cell change, e.g. in case the HO criteria is met. This command is given to the UE in S340 by using a L2 MAC CE command.

In parallel to the above described L1/L2 centric inter-cell mobility procedure executed in connection with the gNB-DU, in the present example, the gNB-CU-CP decides in S335 to initiate an inter-gNB mobility event. This is based, for example, on the evaluation of the L3 measurements.

For this purpose, in S355, the gNB-CU-CP sends to a target node, which is determined by processing the L3 measurements from the UE, such as to gNB2 (target gNB-CU-CP) a handover request via Xn interface.

The target node processes the HO request and prepares the handover, including a response to it, which is sent back to the requesting gNB1 in S360 as a HO ACK message. In this processing, the target node (gnB2) prepares, on the basis of the information included in the request, which includes the configuration used at the target cell, a target configuration (i.e. RRC configuration) for the target cell to be connected in the HO between the gNBs. This target configuration information may be generated based on the current serving cell configuration provided by the source node (i.e. the source gNB-CU-CP) based on the current knowledge of the gNB-CU-CP, i.e at the time of sending the handover request message. It is to be noted that the resulting target configuration so generated using the source configuration provided by the source node is called delta configuration which defines only the configurational differences between the source (i.e. serving) cell configuration and the target configuration.

However, in the scenario illustrated in FIG. 3, the UE is presently also executing a L1/L2 centric inter-cell HO. In this context, the UE conducts in S345, after receiving and processing the MAC CE HO command in S340, a RACH procedure or sends a UL MAC CE to indicate L1 centric serving cell change is successful. The corresponding gNB-DU notifies in S350 the gNB-CU-CP of the L1 centric serving cell change.

It is to be noted that an average or normal transport delay over F1 is considered to be 3-5 ms, for example. In case the gNB-CU-CP decides to initiate, in this period, an inter-gNB HO request over Xn (as done in S335 in FIG. 3), the source configuration information provided by the source gNB based on the current serving cell does not consider the already executed L1 centric inter-cell HO. Hence, the target gNB prepares the target RRC configuration based on the previous serving cell (as indicated by the configuration sent by serving gNB-CU-CP in the HO request in S355).

Consequently, the RRC configuration which is provided to the source gNB-CU-CP in S360 is not associated with the UE's current serving cell. Consequently, if this target configuration is delivered to the UE, e.g. by a corresponding RRC reconfiguration message, it is incorrect, as the UE may not be able to generate the correct full target cell configuration based on the provided delta configuration and could lead to HO failure and RLF. Thus, in S370, a configuration mismatch is to be deduced.

Thus, in summary, the following points are to be considered. There may be a ping-pong effect in the events leading to a (inter-DU or intra-DU) cell change (e.g. due to a fast beam switching), so that a L1 centric serving cell change may be frequently and dynamically executed, which makes the above described race condition likely to happen. Due to this race condition, a scenario may happen where the UE may undergo HO failure and subsequently RLF.

In other words, a case has to be considered in which the CU-CP has configured L1 mobility for a plurality of cells in one or more DUs, wherein the DU autonomously execute HOs based on L1 measurements. After an L1 mobility execution, the new serving cell ID is notified to the CU-CP. In parallel, the gNB-CU-CP also receives L3 measurements and might (based on the measurements) initiate an inter-gNB HO by sending Xn: HO Request to a neighboring target gNB. The target gNB prepares a delta target HO configuration based on the serving cell configuration provided by the source CU-CP. The delta target HO configuration is sent in the Xn: HO Request Ack to the source CU-CP. Meanwhile, the DU has executed a L1 mobility and sent the notification to CU-CP. This notification has reached CU-CP after the HO request has been sent to the target gNB. Thus, the target delta configuration is based on an outdated serving cell information which is incorrect and lead to unpredictable behavior and even RLF.

In order to deal with this problem, it could be conceived that the source gNB-CU-CP re-prepares the target gNB which is however only useful if the serving cell change notification from gNB-DU is received before an RRC message is sent to UE. Therefore, this approach may be too late, wherein it is to be noted that also a signaling and latency overhead is associated therewith. It is also to be noted that the same race condition may re-occur in the second attempt, causing an invalid configuration to be received at the source CU-CP the second time also.

A further approach may be to avoid collision of L3 and L1 mobility procedures and to ensure that the UE is not prevented from moving to the best cell which allows to avoid RLF. In order to avoid that a cell change initiated by the DU with a L3 HO command, it may be considered that whenever the CU-CP is sending a L3 HO request and/or command, it shall include a FLAG in the F1 AP message to indicate that the RRC message is due to a L3 HO. This can pre-empt L1/L2 HO attempts when L3 HO is being prepared/executed in anticipation of this (i.e. if DU doesn't know about L3 HO reports, CU can tell DU via F1AP that L3 HO is being prepared so DU can act accordingly). Alternatively, whenever the gNB-CU-CP triggers an inter-DU HO, it indicates to the UE's source DU using a F1 message to pause L1/L2 centric inter-cell change until a RESUME L1/L2 centric inter-cell change command is sent. As a further alternative, the UE indicates to the DU (e.g. via a MAC CE) whenever a L3 measurement report is sent to the CU-CP based on events (e.g.: A3/A5). This allows the DU to predict the CU behavior.

However, the above discussed options are sub-optimal in nature and not efficient to overcome the described race condition or requires additional signaling resources or consume additional time which may delay a successful HO procedure.

Consequently, according to examples of embodiments, measures are provided which allow to deal with the above described situation while additional signaling load or increased processing time is avoided. Specifically, measures according to the present invention allow to execute a handover procedure in a higher layer, such as an L3 handover procedure for changing an access node, such as a gNB, when lower layer mobility, such a L1/L2 centric inter cell mobility, is configured, without conflict.

According to examples of embodiments, in a scenario as that described above, i.e. when lower layer mobility is configured for a UE in which the UE can change between cells each having different configuration (e.g. RRC configuration), a higher layer mobility procedure is based on a so-called reference configuration which is used for (higher layer) handover preparation. That is, the target node for the higher layer mobility procedure is informed by the source node about a reference configuration, and the UE is informed about the used reference configuration, e.g. by indicating an identifier for the reference configuration in HO command.

Furthermore, according to examples of embodiments, the reference configuration used for the mobility procedure can be determined from different configuration. For example, as the reference configuration, the configuration of the UE with regard to the primary cell associated with the lower layer mobility via RRC signaling can be used. That is, a primary cell or PCell of the UE in the given gNB-DU can be used as the source for the reference configuration. For example, if there are multiple cells of the same DU associated with inter-cell beam management for L1/L2 based mobility, the primary cell could be considered as the one which provided the initial serving cell configuration.

As another alternative, the reference configuration can be determined to be the current (or latest known) serving cell configuration. That is, the source gNB-CU-CP selects the latest known serving cell configuration at the time of handover preparation. In this case, the source gNB informs the target gNB about the selected cell configuration by means of an identifier for the selected configuration or the selected cell wherein a corresponding indication is included in the HO command prepared by target cell to towards the UE.

Moreover, according to further examples of embodiments, the reference configuration can be based on any other (previously used or known) configuration setting which fulfills certain criteria. For example, when the lower layer mobility is configured with inter-cell beam management (ICBM), when a L3 handover is triggered, the target cell (of the gNB2, for example) does not need to continue with the current ICBM configuration. In such cases, a pre-ICBM configuration can be determined by the source gNB as the reference configuration (i.e. the criteria is that the configuration is not related to ICBM, in the present example), wherein the L3 handover can be based on this reference configuration. For this option, the UE has either stored information or access to information which define the corresponding configuration. That is, the UE has not released the configuration of the previously used serving cell. For example, when the cell configuration for L1 centric mobility is sent only using RRC, the source gNB-CU-CP is aware that the previously used serving cell should not be released from the list of preconfigured cells eligible for L1 centric mobility, whenever L3 handover is initiated and thus available to the UE.

In case the UE receives a HO command, such as a RRC reconfiguration message which includes an indication (e.g. an identifier) for the reference configuration as a part of a target cell configuration included in the HO command, at the time of handover execution, the UE uses this reference configuration for generating target cell configuration (e.g. by adapting the information obtained by the delta target configuration information according to the reference configuration) and starts the handover execution.

Due to the above described measures, when a lower layer mobility is configured with multiple configurations for each cell in the lower layer mobility set, it is possible to conduct a higher layer mobility procedure (e.g. a L3 handover) without conflict for handover execution due to lower layer mobility wherein the issue with a race condition described above can be overcome.

That is, when reflecting the above described measures to the scenario described above with regard to the 5G network configuration, whenever a UE has been configured for L1/L2 centric inter-cell mobility, the source gNB-CU-CP determines a reference configuration (e.g. the current source serving cell configuration) and includes an information regarding the reference configuration (e.g. the source serving cell ID) in the Xn: Handover Request. In addition, the reference configuration information also indicates, e.g. by using an information element or a flag, to the target gNB-CU-CP to include an indication of the reference configuration, such as an ID of the source serving cell, as part of the target RRC configuration encoded by the target gNB (e.g. in the target RRC configuration or as a separate information element). It is to be noted that this leads to an introduction of the ID or the like of the source serving cell in the HO command to the UE, based on the indication given, from the target gNB, in response to the HO request. That is, the target gNB provides an information for the UE to use the configuration related to the cell identified by the ID for generating the target RRC configuration from the delta configuration (i.e. on the basis of the configuration associated to the indicated cell ID).

In other words, when the reference configuration is used for handover preparation for the higher level mobility, the indication of the reference configuration, such as the source cell identifier, is forwarded towards the UE in HO command allowing to determine which (known) configuration is to be used for generating the actual target cell configuration.

In case the UE receives the RRC Reconfiguration with the target configuration and the reference configuration indication (e.g. the source serving cell ID or the identifier for reference configuration), the UE generates the (complete) target cell configuration and starts the handover execution.

That is, according to examples of embodiments, a problem is solved which occurs when a target delta HO configuration is built on the current serving cell A and this cell changes in the meantime, e.g. due to L1 mobility where the former serving cell A might have been changed to cell B (see FIG. 2). Since the configuration of cell B can be different compared to the configuration of cell A, the delta configuration provided by the target gNB to the UE is not valid anymore. When using, as explained above, a commonly known reference configuration which the target gNB uses for preparing the target delta HO configuration and indicates this (e.g. with the serving cell ID) to the UE, the UE is able to obtain the reference configuration, even in case it is the configuration of a previous serving cell (e.g. cell A) which is still available at the UE. Hence, the UE can derive the (actual) target cell configuration, even if there was a serving cell change due to L1 mobility.

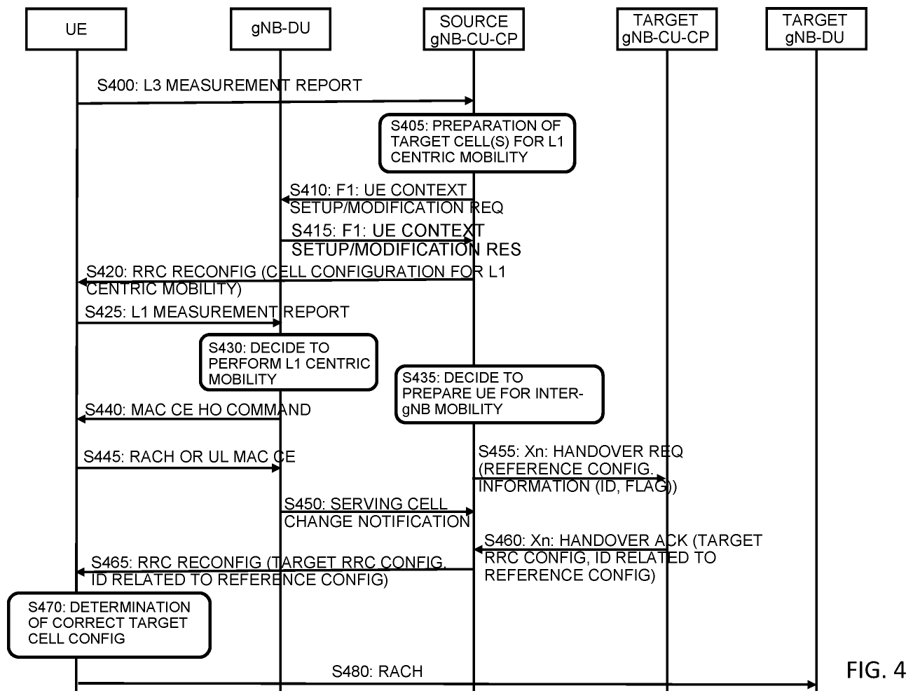

FIG. 4 shows a signaling diagram illustrating an example of a mobility scenario according to examples of embodiments in which a L1/L2 centric inter-cell mobility and a L3 inter-gNB mobility procedure is possible. It is to be noted that the scenario as shown in FIG. 4 is similar to that of FIG. 3, so that in the following mainly the differences in the processing will be described, while for common parts reference is made to the description of FIG. 3.

That is, as in the example according to FIG. 3, it is assumed that the gNB-CU-CP of the source node (i.e. the currently serving cell) configures one or more intra or inter DU cells for L1/L2 centric inter-cell mobility and that the gNB-CU-CP configures the UE for both L1 RSRP and L3 measurements, while providing the RRC configurations for the cells prepared for L1 centric mobility.

The processing according to S400 to S450 according to FIG. 4 is comparable to that according to S300 to 350 of FIG. 3, with the following exception, so that a detailed explanation thereof is not repeated.

As indicated above, according to examples of embodiments, the source gNB (i.e. the gNB-CU-CP) determines a reference configuration (e.g. the Pcell configuration, the currently used (or known) serving cell configuration, or another configuration fulfilling certain criteria (e.g. pre-ICBM configuration). A corresponding determination can be conducted, for example, in connection with one or both of S405 and S435, for example.

Similarly to the example in FIG. 3, in S455, in parallel to the L1/L2 centric inter-cell mobility procedure executed in connection with the gNB-DU, the gNB-CU-CP decides in S435 to initiate an inter-gNB mobility event. This is based, for example, on the evaluation of the L3 measurements.

For this purpose, in S455, the gNB-CU-CP sends to a target node, which is determined by processing the L3 measurements from the UE, such as to gNB2 (target gNB-CU-CP) a handover request via Xn interface. According to examples of embodiments, the handover request in S455 is provided with information regarding the reference configuration determined beforehand. That is, as described above, for example, an identifier for the reference configuration or a corresponding cell is included (e.g. the serving cell ID), and an indication, such as a flag, is added which informs the target node that the identifier of the reference configuration is to be returned together with a target cell configuration.

Then, the target node processes the HO request of S455 and prepares the HO (i.e. a target handover configuration) as well as a response to the request, which is sent back to the requesting gNB1 in S460 as a HO ACK message. In this processing, the target node (gNB2) prepares, on the basis of the information included in the request of S455, which includes information about the reference configuration, a target cell configuration (i.e. RRC configuration) for the target cell to be connected to in the HO between the gNBs. The resulting target cell configuration is presented as a delta configuration which defines the differences between the reference configuration and the target cell configuration, for example. The target cell configuration is then transmitted to the source node (gNB1) together with an indication of the reference configuration being used, such as a corresponding cell ID. The indication of the reference configuration is provided as a part of the target cell configuration information, for example included therein or as an added information part.

In S465, the source gNB-CU-CP sends an RRC reconfiguration message to the UE which commands the HO to the target node (gNB2). In this message, the gNB-CU-CP includes, besides the information regarding the target cell configuration, also the indication of the reference configuration which is used for preparing it, such as the cell ID related to the reference configuration.

That is, the introduction of the indication (e.g. the ID) of the cell in the HO command to the UE is based on the indication given, from the target gNB, in response to the HO request. That is, the information from the target gNB implies an information for the UE to use the configuration related to e.g. the cell identified by the ID for generating the target cell configuration from the delta configuration information.

In S470, when receiving the RRC reconfiguration message together with the reference configuration indication, the UE compares the reference configuration indication with the currently used configuration. For example, the cell ID indicated in the reference configuration indication is compared with the current cell ID.

In case the comparison leads to a matching result, this means that the reference configuration used for the preparation of the target configuration is based on the currently valid serving cell configuration (i.e. any cell change was considered by the source gNB when requesting the inter-gNB HO). Therefore, the target configuration can be directly processed, for example by deducing the full configuration from the delta target configuration information.

Otherwise, in case it is determined that the reference configuration indication does not match to the current configuration setting (i.e. a L1 cell change was conducted which is not considered by the source gNB), the UE deduces the correct target configuration by obtaining information for the configuration matching to the reference configuration indication. For example, in case the reference configuration was a configuration of a previously used serving cell, the information defining the configuration in the corresponding cell can be obtained from stored information and then used in the delta configuration processing so as to achieve a correct target configuration.

Then, in S480, the UE conducts the HO procedure to the new target node, e.g. by conducting a RACH procedure with the gNB-DU of the target node which controls the target cell indicated in the target configuration.

That is, according to the example described in connection with FIG. 4, even in case the UE is executing a L1/L2 centric inter-cell HO which is indicated to the gNB-CU-CP not before the L3 handover is initiated, the target gNB prepares the target RRC configuration based on the reference configuration about which the UE is also informed. This can be used by the UE to deduce to correct target configuration. Consequently, the RRC configuration which is provided to the gNB-CU-CP in S460 can be correctly processed by the UE so that HO failure and RLF can be avoided.

It is to be noted that since the cell configuration for L1 centric mobility is sent only using RRC, the source gNB-CU-CP is assumed to be aware that the previous serving cell should not be released from the list of preconfigured cells eligible for L1 centric mobility which allows to select a suitable reference configuration by the source gNB.

Thus, according to examples of embodiments, it is possible that a higher layer mobility procedure, such as a L3 handover, is completed successfully without any conflict with lower layer mobility.

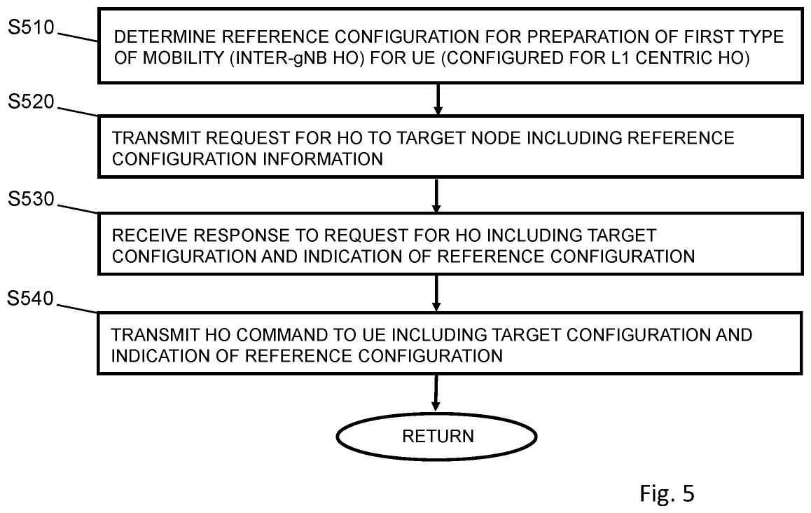

FIG. 5 shows a flow chart of a processing executed by a network element or network function configured to control a communication of at least one communication element or function (e.g. one or more UEs) in a communication network and to operate as a source node in a mobility procedure according to examples of embodiments. That is, FIG. 5 shows a flowchart related to a processing conducted by a gNB 20 (gNB-CU-CP) as also described in connection with FIG. 4.

In S510, a reference configuration to be used for preparing a first type of mobility procedure for a communication element or communication function which is configured to conduct a second type of mobility procedure being different to the first type of mobility procedure is determined.

According to examples of embodiments, the reference configuration is a resource configuration setting used by the communication element or communication function in a primary cell associated with the second type of mobility procedure (i.e. for the L1/L2 centric mobility procedure) designated in the part of the communication network controlled by the communication network control element or communication network control function, such as a Pcell of the gNB1 acting as the current serving node. Alternatively, the reference configuration is a resource configuration setting used by the communication element or communication function a current serving cell of the part of the communication network controlled by the communication network control element or communication network control function (i.e. the current serving cell which the source node is aware of). Moreover, as a further alternative, the reference configuration is a resource configuration setting used by the communication element or communication function in a previously used serving cell of the part of the communication network controlled by the communication network control element or communication network control function, wherein the previously used serving cell was used under a specified condition and it is known that the resource configuration setting used in the previously used serving cell is available for the communication element or communication function (i.e. the configuration is e.g. not released at the UE); for example, the previously used serving cell being used for the reference configuration is that having a pre-ICBM configuration.

In S520, to a target communication network control element or communication network control function to which the communication of the communication element or communication function is to be changed (in the first type of mobility, such as the gNB 30), a request for preparing a target cell configuration for execution of the first type of mobility procedure is transmitted. The request includes information indicating the reference configuration being determined in S510.

According to examples of embodiments, the information indicating the reference configuration and included in the request for preparing the target cell configuration for execution of the first type of mobility procedure includes an identification of a cell for which the reference configuration is set (e.g. serving cell ID, Pcell ID etc.). Furthermore, an indication informing the target communication network control element or communication network control function to use the reference configuration for preparing the target cell configuration for execution of the first type of mobility procedure and to include, in the target cell configuration sent in the response to the request, the identification of the cell for which the reference configuration is set is included. This indication is, for example, a corresponding flag.

In S530, from the target communication network control element or communication network control function to which the request in S520 is transmitted, a response to the request for preparing the target cell configuration for execution of the first type of mobility procedure is received. The response includes an indication of the reference configuration (e.g. the cell ID indicated in the request in S520) and configuration information of a target cell for the first type of mobility procedure for the communication element or communication function.

According to examples of embodiments, the response to the request for preparing the target cell configuration for execution of the first type of mobility procedure includes, as the indication of the reference configuration, an identification of the cell for which the reference configuration is set. Moreover, according to examples of embodiments, the configuration information of the target cell for the first type of mobility procedure for the communication element or communication function defines a delta configuration information considering differences between a resource configuration setting defined by the reference configuration and a resource configuration setting for the target cell of the first type of mobility procedure.

In S540, in order to further proceed in the HO in the first type of mobility, a command for executing the first type of mobility procedure is transmitted to the communication element or communication function. The command includes the indication of the reference configuration (such as the cell ID) and the configuration information of the target cell for the first type of mobility procedure (e.g. the delta configuration information).

According to examples of embodiments, the communication network control element or communication network control function functions as a centralized unit in a disaggregated configuration for a communication network control element or communication network control function such as a gNB. Furthermore, according to examples of embodiments, the first type of the mobility procedure for the communication element or communication function comprises a L3 related handover procedure of the communication from the communication network control element or function (e.g. source gNB 20) to the target communication network control element or target communication network control function (e.g. target gNB 30), i.e. an inter-gNB HO. On the other hand, the second type of the mobility procedure for the communication element or communication function comprises a L1/L2 related handover procedure of the communication from one cell of the communication network part controlled by the communication network control element or communication network control function to another cell of the communication network part controlled by the communication network control element or communication network control function (e.g. an inter-gNB-DU or intra-gNB-DU HO).

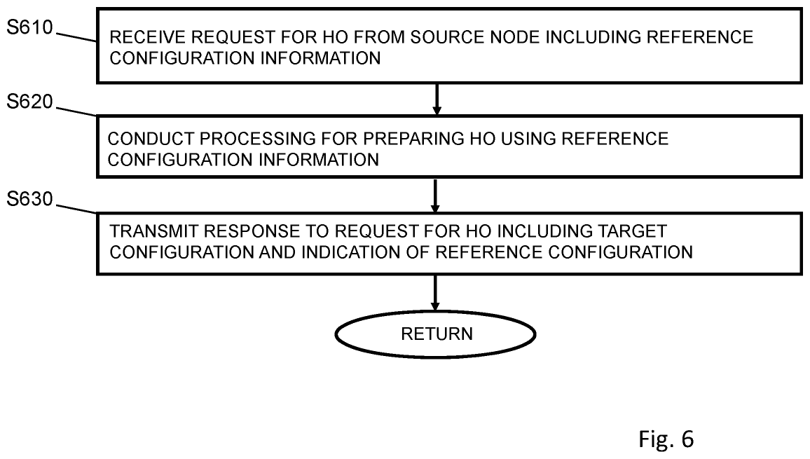

FIG. 6 shows a flow chart of a processing executed by a network element or network function configured to control a communication of at least one communication element or function (e.g. one or more UEs) in a communication network and to operate as a target node in a mobility procedure according to examples of embodiments. That is, FIG. 6 shows a flowchart related to a processing conducted by a gNB 30 (gNB-CU-CP) as also described in connection with FIG. 4.

In S610, from a source communication network control element or communication network control function from which the communication of the communication element or communication function is to be changed (e.g. from gNB 20), a request for preparing a target cell configuration for execution of a first type of mobility procedure is received. The request being received includes information indicating a reference configuration to be used for preparing the target cell configuration for the first type of mobility procedure.

According to examples of embodiments, the information indicating the reference configuration and included in the request for preparing the target cell configuration for execution of the first type of mobility procedure includes an identification of a cell for which the reference configuration is set (e.g. serving cell ID, Pcell ID etc.). Furthermore, an indication informing the target communication network control element or communication network control function to use the reference configuration for preparing the target cell configuration for execution of the first type of mobility procedure and to include, in the target cell configuration which is sent in the response to the request, the identification of the cell for which the reference configuration is set is included. This indication is, for example, a corresponding flag.

In S620, a process for preparing the target cell configuration for execution of the first type of mobility procedure is conducted. The process comprises a determination of configuration information for a target cell for the first type of mobility procedure for the communication element or communication function considering the reference configuration. For example, the reference configuration is used as a basis for preparing delta configuration information indicating the setting for a target cell configuration for the first type of mobility, i.e. a configuration setting for a target cell of the gNB 30, for example, to which the communication is to be changed.

In S630, a response to the request for preparing the target cell configuration for execution of the first type of mobility procedure it transmitted to the source communication network control element or communication network control function. The response includes an indication of the reference configuration as a part of the configuration information of the target cell for the first type of mobility procedure for the communication element or communication function.

According to examples of embodiments, the response to the request for preparing the target cell configuration for execution of the first type of mobility procedure includes, as the indication of the reference configuration, an identification of the cell for which the reference configuration is set. Moreover, according to examples of embodiments, the configuration information of the target cell for the first type of mobility procedure for the communication element or communication function defines a delta configuration information considering differences between a resource configuration setting defined by the reference configuration and a resource configuration setting for the target cell of the first type of mobility procedure.

According to examples of embodiments, the communication network control element or communication network control function functions as a centralized unit in a disaggregated configuration for a communication network control element or communication network control function such as a gNB. Furthermore, according to examples of embodiments, the first type of the mobility procedure for the communication element or communication function comprises a L3 related handover procedure of the communication from a source communication network control element or function (e.g. source gNB 20) to the target communication network control element or target communication network control function (e.g. the target gNB 30), i.e. an inter-gNB HO.

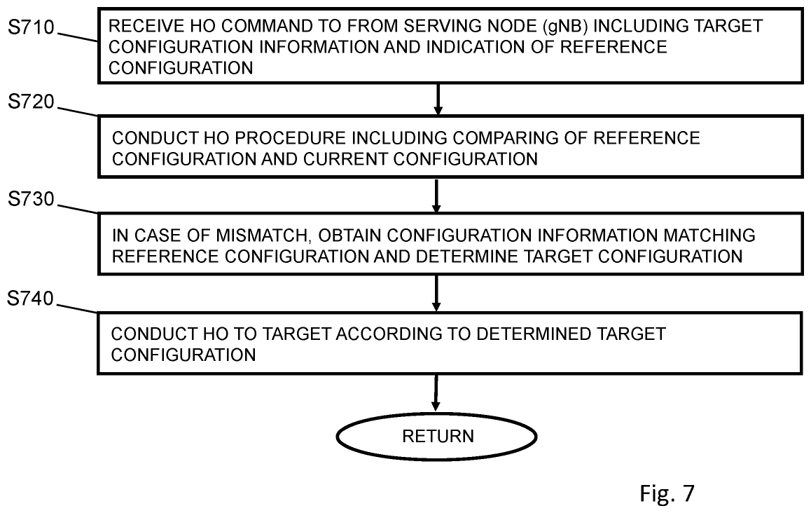

FIG. 7 shows a flow chart of a processing executed by a network element or network function configured to conduct a communication and a communication change in a communication network in a mobility procedure according to examples of embodiments. That is, FIG. 7 shows a flowchart related to a processing conducted by a UE 10 as also described in connection with FIG. 4. The communication element or communication function is configured to conduct a first type of mobility procedure and a second type of mobility procedure being different to the first type of mobility procedure.

In S710, a command for executing the first type of mobility procedure is received from a source communication network control element or communication network control function (e.g. the gNB 20). The command includes an indication of a reference configuration and configuration information of a target cell for the first type of mobility procedure.

According to examples of embodiments, the reference configuration is a resource configuration setting used by the communication element or communication function in a primary cell associated with the second type of mobility procedure, designated in the part of the communication network controlled by the source communication network control element or source communication network control function, such as a Pcell of the gNB1 acting as the current serving node. Alternatively, the reference configuration is a resource configuration setting used by the communication element or communication function in a current or former serving cell of the part of the communication network controlled by the source communication network control element or source communication network control function (i.e. the current serving cell which the source node is aware of). As an alternative, the reference configuration is a resource configuration setting used by the communication element or communication function in a previously used serving cell of the part of the communication network controlled by the source communication network control element or source communication network control function, wherein the previously used serving cell was used under a specified condition wherein the resource configuration setting used in the previously used serving cell is available (e.g. stored or accessible); for example, the previously used serving cell being used for the reference configuration is that having a pre-ICBM configuration.

Moreover, according to examples of embodiments, the indication of the reference configuration included in the command for executing the first type of mobility procedure includes an identification of a cell for which the reference configuration is set (e.g. Pcell ID, serving cell ID and the like).

In S720, the command for executing the first type of mobility procedure is processed. In the processing, the indication of the reference configuration is compared with information specifying a currently used and/or stored configuration for the communication. This process is executed so as to determine whether the currently used configuration is the basis for the target configuration, that is whether the source communication network control element or source communication network control function was aware of any former mobility procedure according to the second type when starting the first type of mobility procedure (for example, in case an inter-gNB HO is initated).

In S730 in case that the comparison results in that the currently used or stored configuration does not match with the reference configuration, configuration information corresponding to the reference configuration is obtained, for example from an internal memory or from the network. Based on the obtained information, which may be different to the currently used configuration setting, the actual target cell configuration for the first type of mobility procedure is determined.

It is to be noted that in case the reference configuration matched the currently used configuration (e.g. when the current cell ID is the same as the cell ID included in the HO command) the current configuration information is used for determining the target cell configuration setting.

According to examples of embodiments, the indication of the reference configuration includes an identification of the cell for which the reference configuration is set. Moreover, according to examples of embodiments, the configuration information of the target for the first type of mobility procedure for the communication element or communication function defines a delta configuration information considering differences between a resource configuration setting defined by the reference configuration and a resource configuration setting for the target cell of the first type of mobility procedure.

In S740, the first type of mobility procedure for changing the communication to a target communication network control element or target communication network control function (e.g. the gNB 30) is conducted on the basis of the determined target cell configuration.

According to examples of embodiments, the source communication network control element or source communication network control function functions as a centralized unit in a disaggregated configuration for a communication network control element or communication network control function such as a gNB. Furthermore, according to examples of embodiments, the first type of the mobility procedure for the communication element or communication function comprises a L3 related handover procedure of the communication from the source communication network control element or function (e.g. source gNB 20) to the target communication network control element or target communication network control function (e.g. target gNB 30), i.e. an inter-gNB HO. On the other hand, the second type of the mobility procedure for the communication element or communication function comprises a L1/L2 related handover procedure of the communication from one cell of the communication network part controlled by the source communication network control element or source communication network control function to another cell of the communication network part controlled by the source communication network control element or source communication network control function (e.g. an inter-gNB-DU or intra-gNB-DU HO).

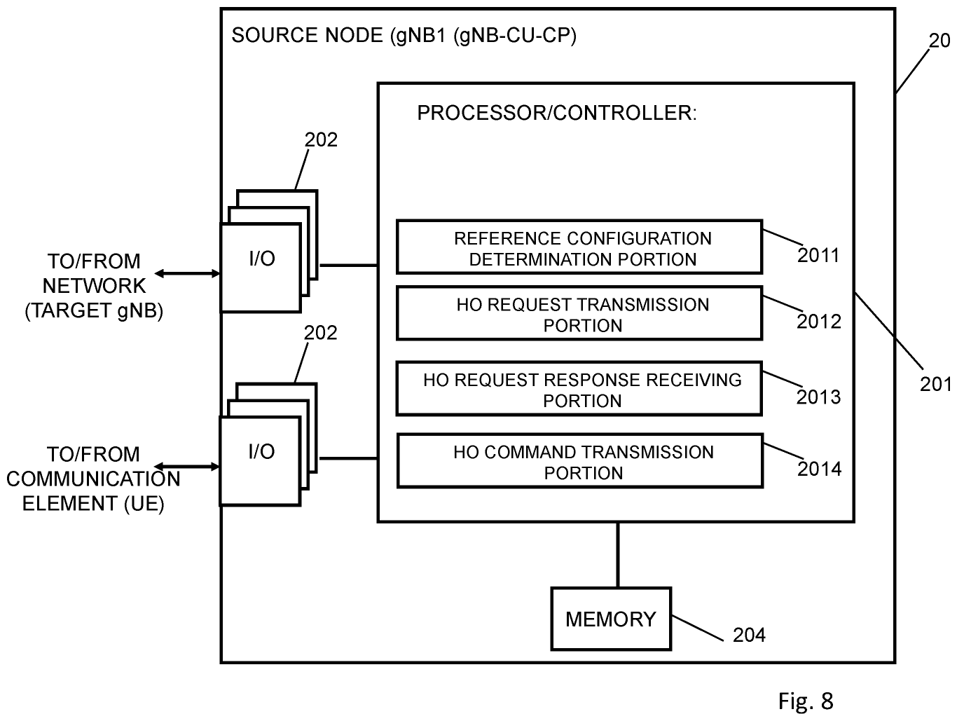

FIG. 8 shows a diagram of a communication network control element being a source node in a mobility scenario according to some examples of embodiments, as described in connection with FIGS. 1 and 4, for example the gNB 20 (gNB-CU-CP) which is configured to conduct a processing according to examples of embodiments of the disclosure. It is to be noted that the network element or function such as the gNB 20 may include further elements or functions besides those described herein below. Furthermore, even though reference is made to a network element or function, the element or function may be also another device or function having a similar task, such as a chipset, a chip, a module, an application etc., which can also be part of a network element or attached as a separate element to a network element, or the like. It should be understood that each block and any combination thereof may be implemented by various means or their combinations, such as hardware, software, firmware, one or more processors and/or circuitry.

The gNB 20 shown in FIG. 8 may include a processing circuitry, a processing function, a control unit or a processor 201, such as a CPU or the like, which is suitable for executing instructions given by programs or the like related to the control procedure. The processor 201 may include one or more processing portions or functions dedicated to specific processing as described below, or the processing may be run in a single processor or processing function. Portions for executing such specific processing may be also provided as discrete elements or within one or more further processors, processing functions or processing portions, such as in one physical processor like a CPU or in one or more physical or virtual entities, for example. Reference signs 202 and 203 denote input/output (I/O) units or functions (interfaces) connected to the processor or processing function 201. The I/O units 202 may be used for communicating with network functions such as the target gNB 30 (e.g. via Xn interface), as shown in FIG. 1. The I/O units 203 may be used for communicating with communication network elements or functions such as UE 10, as shown in FIG. 1. The I/O units 202 and 203 may be combined units including communication equipment towards several entities, or may include a distributed structure with a plurality of different interfaces for different entities. Reference sign 204 denotes a memory usable, for example, for storing data and programs to be executed by the processor or processing function 201 and/or as a working storage of the processor or processing function 201. It is to be noted that the memory 204 may be implemented by using one or more memory portions of the same or different type of memory.

The processor or processing function 201 is configured to execute processing related to the above described mobility procedure. In particular, the processor or processing circuitry or function 201 includes one or more of the following sub-portions. Sub-portion 2011 is a processing portion which is usable as a portion for determining a reference configuration. The portion 2011 may be configured to perform processing according to S510 of FIG. 5. Furthermore, the processor or processing circuitry or function 201 may include a sub-portion 2012 usable as a portion for transmitting a HO request. The portion 2012 may be configured to perform a processing according to S520 of FIG. 5. In addition, the processor or processing circuitry or function 201 may include a sub-portion 2013 usable as a portion for receiving a response to the HO request. The portion 2013 may be configured to perform a processing according to S530 of FIG. 5. Moreover, the processor or processing circuitry or function 201 may include a sub-portion 2014 usable as a portion for transmitting a HO command. The portion 2014 may be configured to perform a processing according to S540 of FIG. 5.

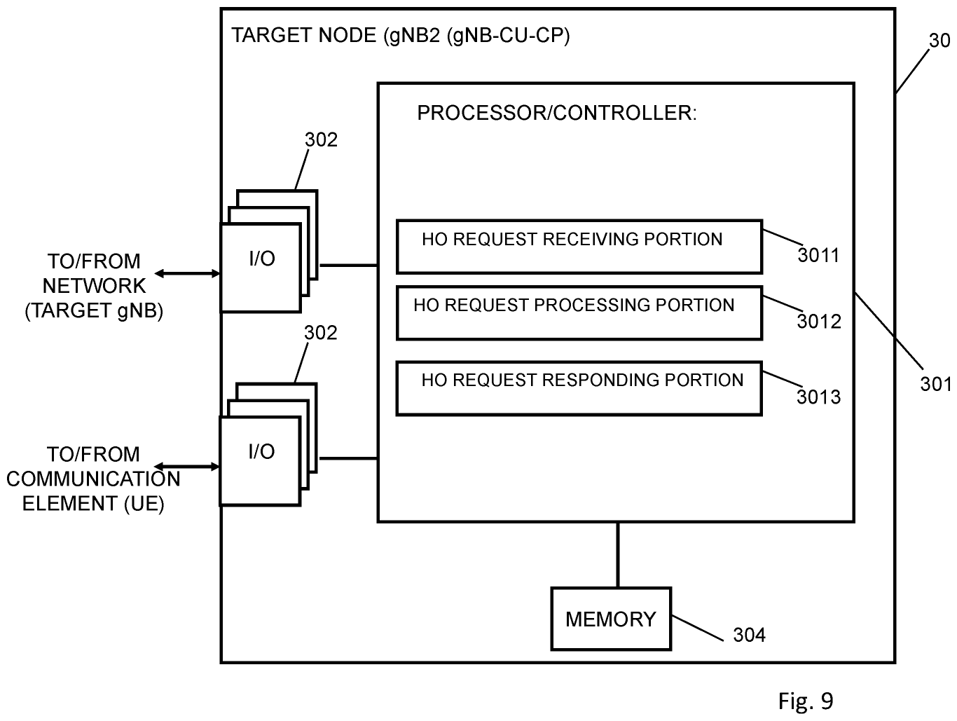

FIG. 9 shows a diagram of a communication network control element being a target node in a mobility scenario according to some examples of embodiments, as described in connection with FIGS. 1 and 4, for example the gNB 30 (gNB-CU-CP) which is configured to conduct a processing according to examples of embodiments of the disclosure. It is to be noted that the network element or function such as the gNB 30 may include further elements or functions besides those described herein below. Furthermore, even though reference is made to a network element or function, the element or function may be also another device or function having a similar task, such as a chipset, a chip, a module, an application etc., which can also be part of a network element or attached as a separate element to a network element, or the like. It should be understood that each block and any combination thereof may be implemented by various means or their combinations, such as hardware, software, firmware, one or more processors and/or circuitry.

The gNB 30 shown in FIG. 9 may include a processing circuitry, a processing function, a control unit or a processor 301, such as a CPU or the like, which is suitable for executing instructions given by programs or the like related to the control procedure. The processor 301 may include one or more processing portions or functions dedicated to specific processing as described below, or the processing may be run in a single processor or processing function. Portions for executing such specific processing may be also provided as discrete elements or within one or more further processors, processing functions or processing portions, such as in one physical processor like a CPU or in one or more physical or virtual entities, for example. Reference signs 302 and 303 denote input/output (I/O) units or functions (interfaces) connected to the processor or processing function 301. The I/O units 302 may be used for communicating with network functions such as the source gNB 30 (e.g. via Xn interface), as shown in FIG. 1. The I/O units 303 may be used for communicating with communication network elements or functions such as UE 10, as shown in FIG. 1. The I/O units 302 and 303 may be combined units including communication equipment towards several entities, or may include a distributed structure with a plurality of different interfaces for different entities. Reference sign 304 denotes a memory usable, for example, for storing data and programs to be executed by the processor or processing function 301 and/or as a working storage of the processor or processing function 301. It is to be noted that the memory 304 may be implemented by using one or more memory portions of the same or different type of memory.

The processor or processing function 301 is configured to execute processing related to the above described mobility procedure. In particular, the processor or processing circuitry or function 301 includes one or more of the following sub-portions. Sub-portion 3011 is a processing portion which is usable as a portion for receiving a HO request. The portion 3011 may be configured to perform processing according to S610 of FIG. 6. Furthermore, the processor or processing circuitry or function 301 may include a sub-portion 3012 usable as a portion for processing a HO request. The portion 3012 may be configured to perform a processing according to S620 of FIG. 6. In addition, the processor or processing circuitry or function 301 may include a sub-portion 3013 usable as a portion for responding to the HO request. The portion 3013 may be configured to perform a processing according to S630 of FIG. 6.

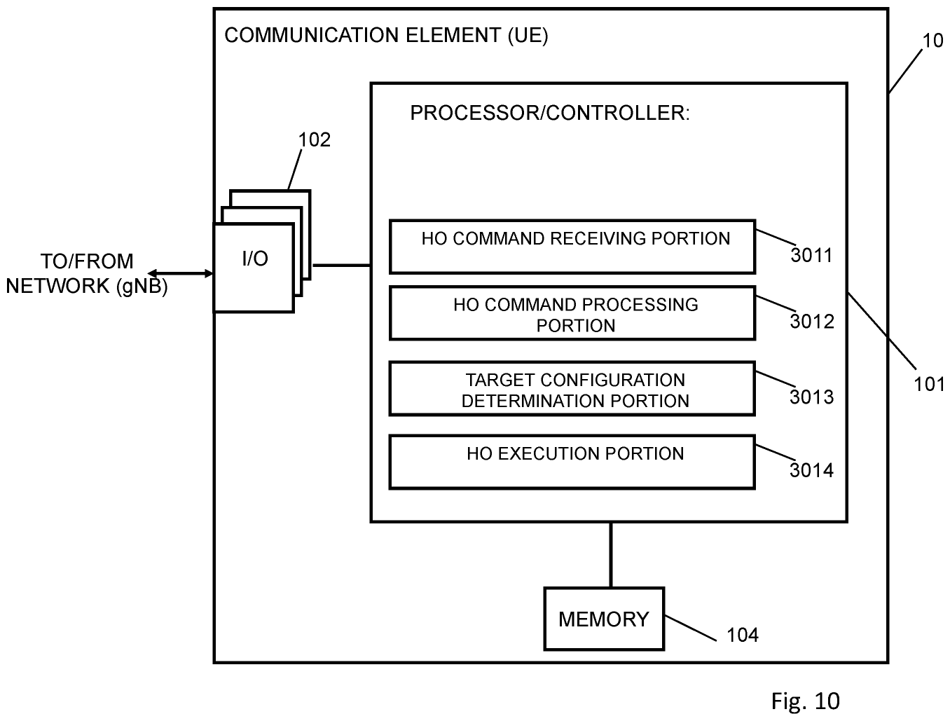

FIG. 10 shows a diagram of a communication element capable of conducting a communication connection change in a mobility scenario according to some examples of embodiments, as described in connection with FIGS. 1 and 4, for example the UE 10 which is configured to conduct a processing according to examples of embodiments of the disclosure. It is to be noted that the network element or function such as the UE 10 may include further elements or functions besides those described herein below. Furthermore, even though reference is made to a network element or function, the element or function may be also another device or function having a similar task, such as a chipset, a chip, a module, an application etc., which can also be part of a network element or attached as a separate element to a network element, or the like. It should be understood that each block and any combination thereof may be implemented by various means or their combinations, such as hardware, software, firmware, one or more processors and/or circuitry.

The UE 10 shown in FIG. 10 may include a processing circuitry, a processing function, a control unit or a processor 101, such as a CPU or the like, which is suitable for executing instructions given by programs or the like related to the control procedure. The processor 101 may include one or more processing portions or functions dedicated to specific processing as described below, or the processing may be run in a single processor or processing function. Portions for executing such specific processing may be also provided as discrete elements or within one or more further processors, processing functions or processing portions, such as in one physical processor like a CPU or in one or more physical or virtual entities, for example. Reference sign 102 denotes input/output (I/O) units or functions (interfaces) connected to the processor or processing function 101. The I/O units 102 may be used for communicating with network functions such as the gNBs 20, 30, as shown in FIG. 1. The I/O units 102 may be combined units including communication equipment towards several entities, or may include a distributed structure with a plurality of different interfaces for different entities. Reference sign 104 denotes a memory usable, for example, for storing data and programs to be executed by the processor or processing function 101 and/or as a working storage of the processor or processing function 101. It is to be noted that the memory 104 may be implemented by using one or more memory portions of the same or different type of memory.

The processor or processing function 101 is configured to execute processing related to the above described mobility procedure. In particular, the processor or processing circuitry or function 101 includes one or more of the following sub-portions. Sub-portion 1011 is a processing portion which is usable as a portion for receiving a HO command. The portion 1011 may be configured to perform processing according to S710 of FIG. 7. Furthermore, the processor or processing circuitry or function 101 may include a sub-portion 1012 usable as a portion for processing the HO command. The portion 1012 may be configured to perform a processing according to S720 of FIG. 7. In addition, the processor or processing circuitry or function 101 may include a sub-portion 1013 usable as a portion for determining a target configuration. The portion 1013 may be configured to perform a processing according to S730 of FIG. 7. Moreover, the processor or processing circuitry or function 101 may include a sub-portion 1014 usable as a portion for executing the HO. The portion 1014 may be configured to perform a processing according to S740 of FIG. 7.

It is to be noted that examples of embodiments of the disclosure are applicable to various different network configurations. In other words, the examples shown in the above described figures, which are used as a basis for the above discussed examples, are only illustrative and do not limit the present disclosure in any way. That is, additional further existing and proposed new functionalities available in a corresponding operation environment may be used in connection with examples of embodiments of the disclosure based on the principles defined.

According to a further example of embodiments, there is provided, for example, an apparatus for use by a communication network control element or communication network control function configured to control a communication of at least one communication element or function in a communication network, the apparatus comprising means configured to determine a reference configuration to be used for preparing a first type of mobility procedure for a communication element or communication function which is configured to conduct a second type of mobility procedure being different to the first type of mobility procedure, means configured to cause transmission, to a target communication network control element or communication network control function to which the communication of the communication element or communication function is to be changed, of a request for preparing a target cell configuration for execution of the first type of mobility procedure, wherein the request includes information indicating the reference configuration, means configured to receive, from the target communication network control element or communication network control function, a response to the request for preparing the target cell configuration for execution of the first type of mobility procedure, the response including an indication of the reference configuration and configuration information of a target cell for the first type of mobility procedure for the communication element or communication function, and means configured to cause transmission, to the communication element or communication function, of a command for executing the first type of mobility procedure, the command including the indication of the reference configuration and the configuration information of the target cell for the first type of mobility procedure.

Furthermore, according to some other examples of embodiments, the above defined apparatus may further comprise means for conducting at least one of the processing defined in the above described methods, for example a method according to that described in connection with FIG. 5.

According to a further example of embodiments, there is provided, for example, an apparatus for use by a communication network control element or communication network control function configured to conduct a mobility procedure to change control of a communication of at least one communication element or function in a communication network, the apparatus comprising means configured to receive, from a source communication network control element or communication network control function from which the communication of the communication element or communication function is to be changed, a request for preparing a target cell configuration for execution of a first type of mobility procedure, wherein the request includes information indicating a reference configuration to be used for preparing the target cell configuration for the first type of mobility procedure, means configured to conduct a process for preparing the target cell configuration for execution of the first type of mobility procedure, wherein the process comprises a determination of configuration information for a target cell for the first type of mobility procedure for the communication element or communication function considering the reference configuration, and means configured to cause transmission, to the source communication network control element or communication network control function, a response to the request for preparing the target cell configuration for execution of the first type of mobility procedure, the response including an indication of the reference configuration as a part of the configuration information of the target cell for the first type of mobility procedure for the communication element or communication function.

Furthermore, according to some other examples of embodiments, the above defined apparatus may further comprise means for conducting at least one of the processing defined in the above described methods, for example a method according to that described in connection with FIG. 6.

According to a further example of embodiments, there is provided, for example, an apparatus for use by a communication element or communication function configured to conduct a communication in a communication network, the apparatus comprising means configured to receive, from a source communication network control element or communication network control function, a command for executing a first type of mobility procedure, the command including an indication of a reference configuration and configuration information of a target cell for the first type of mobility procedure, means configured to process the command for executing the first type of mobility procedure, wherein the processing includes to compare the indication of the reference configuration with information specifying at least one of a currently used configuration and a stored configuration for the communication, means configured, in case that the comparison results in that the currently used or stored configuration does not match with the reference configuration, to obtain configuration information corresponding to the reference configuration, and to determine a target cell configuration for the first type of mobility procedure, and means configured to conduct the first type of mobility procedure for changing the communication to a target communication network control element or target communication network control function on the basis of the determined target cell configuration.

Furthermore, according to some other examples of embodiments, the above defined apparatus may further comprise means for conducting at least one of the processing defined in the above described methods, for example a method according to that described in connection with FIG. 7.

According to a further example of embodiments, there is provided, for example, a non-transitory computer readable medium comprising program instructions for causing an apparatus to perform, when used in communication network control element or communication network control function configured to control a communication of at least one communication element or function in a communication network, a processing comprising determining a reference configuration to be used for preparing a first type of mobility procedure for a communication element or communication function which is configured to conduct a second type of mobility procedure being different to the first type of mobility procedure, causing transmission, to a target communication network control element or communication network control function to which the communication of the communication element or communication function is to be changed, of a request for preparing a target cell configuration for execution of the first type of mobility procedure, wherein the request includes information indicating the reference configuration, receiving, from the target communication network control element or communication network control function, a response to the request for preparing the target cell configuration for execution of the first type of mobility procedure, the response including an indication of the reference configuration and configuration information of a target cell for the first type of mobility procedure for the communication element or communication function, and causing transmission, to the communication element or communication function, of a command for executing the first type of mobility procedure, the command including the indication of the reference configuration and the configuration information of the target cell for the first type of mobility procedure.

According to a further example of embodiments, there is provided, for example, a non-transitory computer readable medium comprising program instructions for causing an apparatus to perform, when used in a communication network control element or communication network control function configured to conduct a mobility procedure to change control of a communication of at least one communication element or function in a communication network, a processing comprising receiving, from a source communication network control element or communication network control function from which the communication of the communication element or communication function is to be changed, a request for preparing a target cell configuration for execution of a first type of mobility procedure, wherein the request includes information indicating a reference configuration to be used for preparing the first type of mobility procedure, conducting a process for preparing the target cell configuration for execution of the first type of mobility procedure, wherein the process comprises a determination of configuration information for a target cell for the first type of mobility procedure for the communication element or communication function considering the reference configuration, and causing transmission, to the source communication network control element or communication network control function, a response to the request for preparing the target cell configuration for execution of the first type of mobility procedure, the response including an indication of the reference configuration as a part of the configuration information of the target cell for the first type of mobility procedure for the communication element or communication function.

According to a further example of embodiments, there is provided, for example, a non-transitory computer readable medium comprising program instructions for causing an apparatus to perform, when used in a communication element or communication function configured to conduct a communication in a communication network, a processing comprising receiving, from a source communication network control element or communication network control function, a command for executing a first type of mobility procedure, the command including an indication of a reference configuration and configuration information of a target cell for the first type of mobility procedure, processing the command for executing the first type of mobility procedure, wherein the processing includes to compare the indication of the reference configuration with information specifying at least one of a currently used configuration and a stored configuration for the communication, in case that the comparison results in that the currently used or stored configuration does not match with the reference configuration, obtaining configuration information corresponding to the reference configuration, and determining a target cell configuration for the first type of mobility procedure, and conducting the first type of mobility procedure for changing the communication to a target communication network control element or target communication network control function on the basis of the determined target cell configuration.

It should be appreciated that
an access technology via which traffic is transferred to and from an entity in the communication network may be any suitable present or future technology, such as WLAN (Wireless Local Access Network), WiMAX (Worldwide Interoperability for Microwave Access), LTE, LTE-A, 5G, Bluetooth, Infrared, and the like may be used; additionally, embodiments may also apply wired technologies, e.g. IP based access technologies like cable networks or fixed lines.
embodiments suitable to be implemented as software code or portions of it and being run using a processor or processing function are software code independent and can be specified using any known or future developed programming language, such as a high-level programming language, such as objective-C, C, C++, C#, Java, Python, Javascript, other scripting languages etc., or a low-level programming language, such as a machine language, or an assembler.
implementation of embodiments is hardware independent and may be implemented using any known or future developed hardware technology or any hybrids of these, such as a microprocessor or CPU (Central Processing Unit), MOS (Metal Oxide Semiconductor), CMOS (Complementary MOS), BiMOS (Bipolar MOS), BiCMOS (Bipolar CMOS), ECL (Emitter Coupled Logic), and/or TTL (Transistor-Transistor Logic).
embodiments may be implemented as individual devices, apparatuses, units, means or functions, or in a distributed fashion, for example, one or more processors or processing functions may be used or shared in the processing, or one or more processing sections or processing portions may be used and shared in the processing, wherein one physical processor or more than one physical processor may be used for implementing one or more processing portions dedicated to specific processing as described,
an apparatus may be implemented by a semiconductor chip, a chipset, or a (hardware) module including such chip or chipset;
embodiments may also be implemented as any combination of hardware and software, such as ASIC (Application Specific IC (Integrated Circuit)) components, FPGA (Field-programmable Gate Arrays) or CPLD (Complex Programmable Logic Device) components or DSP (Digital Signal Processor) components.
embodiments may also be implemented as computer program products, including a computer usable medium having a computer readable program code embodied therein, the computer readable program code adapted to execute a process as described in embodiments, wherein the computer usable medium may be a non-transitory medium.

Although the present disclosure has been described herein before with reference to particular embodiments thereof, the present disclosure is not limited thereto and various modifications can be made thereto.

1-20. (canceled)

21. An apparatus for use by a communication network control element or communication network control function configured to control a communication of at least one communication element or function in a communication network, the apparatus comprising
at least one processing circuitry, and
at least one memory for storing instructions to be executed by the processing circuitry,
wherein the at least one memory and the instructions are configured to, with the at least one processing circuitry, cause the apparatus at least:
to determine a reference configuration to be used for preparing a first type of mobility procedure for a communication element or communication function which is configured to conduct a second type of mobility procedure being different to the first type of mobility procedure,
to cause transmission, to a target communication network control element or communication network control function to which the communication of the communication element or communication function is to be changed, of a request for preparing a target cell configuration for execution of the first type of mobility procedure, wherein the request includes information indicating the reference configuration,
to receive, from the target communication network control element or communication network control function, a response to the request for preparing the target cell configuration for execution of the first type of mobility procedure, the response including an indication of the reference configuration and configuration information of a target cell for the first type of mobility procedure for the communication element or communication function, and
to cause transmission, to the communication element or communication function, of a command for executing the first type of mobility procedure, the command including the indication of the reference configuration and the configuration information of the target cell for the first type of mobility procedure.

22. The apparatus according to claim 21, wherein the reference configuration is a resource configuration setting used by the communication element or communication function in one of
a primary cell associated with the second type of mobility procedure, designated in the part of the communication network controlled by the communication network control element or communication network control function,
a current serving cell of the part of the communication network controlled by the communication network control element or communication network control function, and
a previously used serving cell of the part of the communication network controlled by the communication network control element or communication network control function, wherein the previously used serving cell was used under a specified condition and it is known that the resource configuration setting used in the previously used serving cell is available for the communication element or communication function.

23. The apparatus according to claim 21, wherein the information indicating the reference configuration and included in the request for preparing the target cell configuration for execution of the first type of mobility procedure includes
an identification of a cell for which the reference configuration is set, and
an indication informing the target communication network control element or communication network control function to use the reference configuration for preparing the target cell configuration for execution of the first type of mobility procedure and to include, in the target cell configuration, sent in response to the request, the identification of the cell for which the reference configuration is set.

24. The apparatus according claim 21, wherein
the communication network control element or communication network control function functions as a centralized unit,
the first type of the mobility procedure for the communication element or communication function comprises a layer 3 related handover procedure of the communication from the communication network control element or function to the target communication network control element or target communication network control function, and
the second type of the mobility procedure for the communication element or communication function comprises a layer 1/layer 2 related handover procedure of the communication from one cell of the communication network part controlled by the communication network control element or communication network control function to another cell of the communication network part controlled by the communication network control element or communication network control function.

25. The apparatus according to claim 21, wherein the response to the request for preparing the target cell configuration for execution of the first type of mobility procedure includes, as the indication of the reference configuration, an identification of the cell for which the reference configuration is set, wherein the configuration information of the target cell for the first type of mobility procedure for the communication element or communication function defines a delta configuration information considering differences between a resource configuration setting defined by the reference configuration and a resource configuration setting for the target cell of the first type of mobility procedure.

26. A method for use in communication network control element or communication network control function configured to control a communication of at least one communication element or function in a communication network, the method comprising
determining a reference configuration to be used for preparing a first type of mobility procedure for a communication element or communication function which is configured to conduct a second type of mobility procedure being different to the first type of mobility procedure, causing transmission, to a target communication network control element or communication network control function to which the communication of the communication element or communication function is to be changed, of a request for preparing a target cell configuration for execution of the first type of mobility procedure, wherein the request includes information indicating the reference configuration,
receiving, from the target communication network control element or communication network control function, a response to the request for preparing the target cell configuration for execution of the first type of mobility procedure, the response including an indication of the reference configuration and configuration information of a target cell for the first type of mobility procedure for the communication element or communication function, and
causing transmission, to the communication element or communication function, of a command for executing the first type of mobility procedure, the command including the indication of the reference configuration and the configuration information of the target cell for the first type of mobility procedure.

27. An apparatus for use by a communication network control element or communication network control function configured to conduct a mobility procedure to change control of a communication of at least one communication element or function in a communication network, the apparatus comprising
at least one processing circuitry, and
at least one memory for storing instructions to be executed by the processing circuitry,
wherein the at least one memory and the instructions are configured to, with the at least one processing circuitry, cause the apparatus at least:
to receive, from a source communication network control element or communication network control function from which the communication of the communication element or communication function is to be changed, a request for preparing a target cell configuration for execution of a first type of mobility procedure, wherein the request includes information indicating a reference configuration to be used for preparing the target cell configuration for the first type of mobility procedure,
to conduct a process for preparing the target cell configuration for execution of the first type of mobility procedure, wherein the process comprises a determination of configuration information for a target cell for the first type of mobility procedure for the communication element or communication function considering the reference configuration, and
to cause transmission, to the source communication network control element or communication network control function, a response to the request for preparing the target cell configuration for execution of the first type of mobility procedure, the response including an indication of the reference configuration as a part of the configuration information of the target cell for the first type of mobility procedure for the communication element or communication function.

28. The apparatus according to claim 27, wherein the information indicating the reference configuration and included in the request for preparing the target cell configuration for execution of the first type of mobility procedure includes
an identification of a cell for which the reference configuration is set, and
an indication informing the communication network control element or communication network control function to use the reference configuration for preparing the target cell configuration for execution of the first type of mobility procedure and to include, in the target cell configuration, which is sent in response to the request, the identification of the cell for which the reference configuration is set.

29. The apparatus according to claim 27, wherein
the communication network control element or communication network control function functions as a centralized unit,
the first type of the mobility procedure for the communication element or communication function comprises a layer 3 related handover procedure of the communication from the source communication network control element or function to the communication network control element or communication network control function.

30. The apparatus according to claim 27, wherein the response to the request for preparing the target cell configuration for execution of the first type of mobility procedure includes, as the indication of the reference configuration, an identification of the cell for which the reference configuration is set, wherein the configuration information of the target cell for the first type of mobility procedure for the communication element or communication function defines a delta configuration information considering differences between a resource configuration setting defined by the reference configuration and a resource configuration setting for the target cell of the first type of mobility procedure.

31. An apparatus for use by a communication element or communication function configured to conduct a communication in a communication network, the apparatus comprising
at least one processing circuitry, and
at least one memory for storing instructions to be executed by the processing circuitry,
wherein the at least one memory and the instructions are configured to, with the at least one processing circuitry, cause the apparatus at least:
to receive, from a source communication network control element or communication network control function, a command for executing a first type of mobility procedure, the command including an indication of a reference configuration and configuration information of a target cell for the first type of mobility procedure,
to process the command for executing the first type of mobility procedure, wherein the processing includes to compare the indication of the reference configuration with information specifying at least one of a currently used configuration and a stored configuration for the communication,
in case that the comparison results in that the currently used or stored configuration does not match with the reference configuration, to obtain configuration information corresponding to the reference configuration, and to determine a target cell configuration for the first type of mobility procedure, and
to conduct the first type of mobility procedure for changing the communication to a target communication network control element or target communication network control function on the basis of the determined target cell configuration.

32. The apparatus according to claim 31, wherein the communication element or communication function is further configured to conduct a second type of mobility procedure being different to the first type of mobility procedure.

33. The apparatus according to claim 31, wherein the reference configuration is a resource configuration setting used by the communication element or communication function in one of
a primary cell associated with the second type of mobility procedure, designated in the part of the communication network controlled by the source communication network control element or communication network control function, and
a currently or previously used serving cell of the part of the communication network controlled by the source communication network control element or communication network control function, wherein the resource configuration setting used in the previously used serving cell is available.

34. The apparatus according to claim 31, wherein the indication of the reference configuration included in the command for executing the first type of mobility procedure includes an identification of a cell for which the reference configuration is set.

35. The apparatus according to claim 31, wherein
the source communication network control element or source communication network control function functions as a centralized unit,
the first type of the mobility procedure for the communication element or communication function comprises a layer 3 related handover procedure of the communication from the source communication network control element or source communication network control function to the target communication network control element or target communication network control function, and
a second type of mobility procedure for which the communication element or communication function is configured comprises a layer 1/layer 2 related handover procedure of the communication from one cell of the communication network part controlled by the source communication network control element or source communication network control function to another cell of the communication network part controlled by the source communication network control element or source communication network control function.

36. The apparatus according to any of claim 31, wherein the indication of the reference configuration includes an identification of a cell for which the reference configuration is set, wherein the configuration information of the target for the first type of mobility procedure for the communication element or communication function defines a delta configuration information considering differences between a resource configuration setting defined by the reference configuration and a resource configuration setting for the target cell of the first type of mobility procedure.

37. A computer program product for a computer, including software code portions for performing the steps of claim 26, when said product is run on the computer.

38. The computer program product according to claim 37, wherein
the computer program product includes a computer-readable medium on which said software code portions are stored, and/or
the computer program product is directly loadable into the internal memory of the computer and/or transmittable via a network by means of at least one of upload, download and push procedures.
